(19) United States
(12) Patent Application Publication
(10) Pub. No.: US 2023/0379657 A1
(43) Pub. Date: Nov. 23, 2023

(54) METHOD AND APPARATUS FOR RANGING-BASED SERVICES

(71) Applicant: LENOVO (BEIJING) LIMTED, Beijing (CN)

(72) Inventors: Min XU, Beijing (CN); Haiming WANG, Beijing (CN); Jing HAN, Beijing (CN); Jie HU, Beijing (CN)

(21) Appl. No.: 18/248,779

(22) PCT Filed: Oct. 12, 2020
(86) PCT No.: PCT/CN2020/120439

§ 371 Date: Apr. 12, 2023

(51) Int. Cl. H04W 4/02; G01S 11/02

(52) U.S. Cl. CPC H04W 4/023; G01S 11/02

(57) ABSTRACT

Embodiments of the present application relate to a method and an apparatus for ranging-based services. According to an embodiment of the present application, a method can include: obtaining, at a first user equipment (UE), a configuration associated with ranging information, wherein the configuration indicates content to be included in the ranging information and/or a first triggering condition for reporting the ranging information; and reporting the ranging information according to the configuration. Embodiments of the present application can define content of ranging information, method of reporting ranging information, and trigger condition of the ranging information, thereby facilitating the ranging-based services.

### TECHNICAL FIELD

Embodiments of the present application generally relate to wireless communication technology, especially to a method and apparatus for ranging-based services.

### BACKGROUND

Ranging-based services are the services utilizing the distance and/or direction between two user equipment (UEs), e.g., picture sharing between friends. Typically, ranging does not require the network to deploy positioning infrastructures or provide positioning services, as it may be directly performed between two or more UEs. Ranging-based services are different from positioning services which can be sensitive due to privacy or regulation concerns. Ranging-based services are becoming popular in a variety of verticals such as consumer, smart home, smart city, smart transportation and industry.

### SUMMARY OF THE APPLICATION

Some embodiments of the present application at least provide a technical solution for ranging-based services.

According to some embodiments of the present application, a method may include: obtaining, at a first UE, a configuration associated with ranging information, wherein the configuration indicates content to be included in the ranging information and/or a first triggering condition for reporting the ranging information; and reporting the ranging information according to the configuration.

In an embodiment of the present application, the configuration may be obtained by at least one of: a parameter set preconfigured in the first UE; receiving via system information or a dedicated signalling from a base station (BS); and receiving via system information or a dedicated signalling from a second UE different from the first UE.

In another embodiment of the present application, the configuration may further include at least one of: a maximum number of second UEs whose ranging information can be reported; an indication for reporting the ranging information; and a destination to which the ranging information is reported.

In yet another embodiment of the present application, the content included in the ranging information may include at least one of: an identity (ID) of a second UE different from the first UE; a distance between the first UE and the second UE is smaller or greater than a threshold; the distance between the first UE and the second UE; a minimum, maximum, or an average distance between the first UE and the second UE; a time stamp for recording the ranging information; a time interval between the ranging information and a previous ranging information; a public land mobile network (PLMN) ID; or a cell ID.

In yet another embodiment of the present application, the first triggering condition for reporting the ranging information may include at least one of the following events: 1) an estimated distance between the first UE and the second UE is smaller than or greater than a first threshold; 2) a measurement result of a reference signal from the second UE is smaller than or greater than a second threshold; 3) a transmission delay between the first UE and the second UE is smaller than or greater than a third threshold; 4) the second UE bearing the same area ID as the first UE or bearing a neighboring area ID of the first UE; 5) the second UE is disclosed by a discovery procedure for a short-range connection; 6) at least one of the above events 1)-5) lasts for a duration of time; 7) at least one of the above events 1)-5) occurs a first number of times; or 8) at least one of the above events 1)-5) occurs a second number of times in a period of time; wherein the method may further include: reporting the ranging information in response to the first triggering condition is fulfilled.

In yet another embodiment of the present application, the first triggering condition for reporting the ranging information may include a period for reporting the ranging information, and wherein the method further include: periodically reporting the ranging information based on the period.

In yet another embodiment of the present application, the ranging information is reported to a destination which is one of: a source from which the configuration is received; a destination indicated in the configuration; a destination determined based on a UE type; a destination determined based on a distance or propagation delay between the destination and the first UE; a radio link condition of the first UE.

In yet another embodiment of the present application, the method may further include: transmitting an indication indicating a capability of the first UE associated with the ranging information, wherein the capability may include at least one of: the first UE being capable of recording ranging information; the first UE being capable of reporting ranging information; the content included in ranging information that the first UE is capable of reporting; or at least one triggering condition based on which the first UE is capable of reporting the ranging information.

In yet another embodiment of the present application, the method may further include: transmitting an indication associated with an availability of ranging information of the first UE, wherein the availability may include at least one of: the first UE having ranging information to be reported; content included in the ranging information that the first UE has; and at least one triggering condition for reporting the ranging information that the first UE has.

In yet another embodiment of the present application, the method may further include: receiving a notification, wherein the notification is generated based on the reported ranging information.

According to some other embodiments of the present application, a method may include: transmitting, to a first UE, a configuration for ranging information, wherein the configuration indicates content included in the ranging information and/or a first triggering condition for reporting the ranging information; and receiving the ranging information according to the configuration.

In an embodiment of the present application, the configuration may further include at least one of: a maximum number of second UEs whose ranging information can be reported; an indication for reporting the ranging information; and a destination to which the ranging information is reported.

In another embodiment of the present application, the content included in the ranging information may include at least one of: an ID of a second UE different from the first UE; a distance between the first UE and the second UE is smaller or greater than a threshold; the distance between the first UE and the second UE; a minimum, maximum, or an average distance between the first UE and the second UE; a time stamp for recording the ranging information; a time interval between the ranging information and a previous ranging information; a PLMN ID; or a cell ID.

In yet another embodiment of the present application, the first triggering condition for reporting the ranging information may include at least one of the following events: 1) an estimated distance between the first UE and the second UE is smaller than or greater than a first threshold; 2) a measurement result of a reference signal from the second UE is smaller than or greater than a second threshold; 3) a transmission delay between the first UE and the second UE is smaller than or greater than a third threshold; 4) the second UE bearing the same area ID as the first UE or bearing a neighboring area ID of the first UE; 5) the second UE is disclosed by a discovery procedure for a short-range connection; 6) at least one of the above events 1)-5) lasts for a duration of time; 7) at least one of the above events 1)-5) occurs a first number of times; or 8) at least one of the above events 1)-5) occurs a second number of times in a period of time; wherein the method may further include: reporting the ranging information in response to the first triggering condition is fulfilled.

In yet another embodiment of the present application, the first triggering condition for reporting the ranging information may include a period for reporting the ranging information, and wherein the method further include: periodically reporting the ranging information based on the period.

In yet another embodiment of the present application, the method may further include: receiving an indication indicating capability of the first UE associated with the ranging information, wherein the capability may include at least one of: the first UE being capable of recording ranging information; the first UE being capable of reporting ranging information; the content included in ranging information that the first UE is capable of reporting; and at least one triggering condition based on which first UE is capable of reporting the ranging information.

In yet another embodiment of the present application, the method may further include: receiving an indication associated with an availability of ranging information of the first UE, wherein the availability may include at least one of: the first UE having ranging information to be reported; content included in the ranging information that the first UE has; and at least one triggering condition for reporting the ranging information that the first UE has.

In yet another embodiment of the present application, the method may further include: transmitting a notification to the first UE, wherein the notification is generated based on the received ranging information.

Some embodiments of the present application also provide an apparatus, include: at least one non-transitory computer-readable medium having computer executable instructions stored therein; at least one receiving circuitry; at least one transmitting circuitry; and at least one processor coupled to the at least one non-transitory computer-readable medium, the at least one receiving circuitry and the at least one transmitting circuitry. The computer executable instructions are programmed to implement any method as stated above with the at least one receiving circuitry, the at least one transmitting circuitry and the at least one processor.

Embodiments of the present application provide a technical solution for ranging-based services, such that content of ranging information, method of reporting ranging information, and trigger condition of the ranging information are defined, thereby facilitating the ranging-based services.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system 100 according to some embodiments of the present application;

FIG. 2 illustrates an exemplary application scenarios of ranging-based service according to some embodiments of the present application;

FIG. 3 illustrates an exemplary application scenarios of ranging-based service according to some other embodiments of the present application;

FIG. 4 is a flow chart illustrating a method for ranging-based services according to some embodiments of the present application;

FIG. 5 is a flow chart illustrating a method for ranging-based services according to some other embodiments of the present application;

FIG. 6 is an exemplary method for ranging-based services according to some embodiments of the present application;

FIG. 7 is an exemplary method for ranging-based services according to some other embodiments of the present application; and

FIG. 8 illustrates a simplified block diagram of an apparatus for ranging-based services according to embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. Persons skilled in the art know very well that, with the development of network architecture and new service scenarios, the embodiments in the present application are also applicable to similar technical problems.

To implement ranging-based services, defining ranging information is necessary for the UEs. In addition, to further make full use of ranging information at UEs, exchanging the ranging information between UEs or reporting the ranging information to the base station (BS) should be supported such that the UEs and BS may take further actions based on ranging information.

Given the above, the industry desires an improved technology for ranging-based services, such that content of ranging information, method of reporting ranging information, and trigger condition of the ranging information are defined, thereby facilitating the ranging-based services.

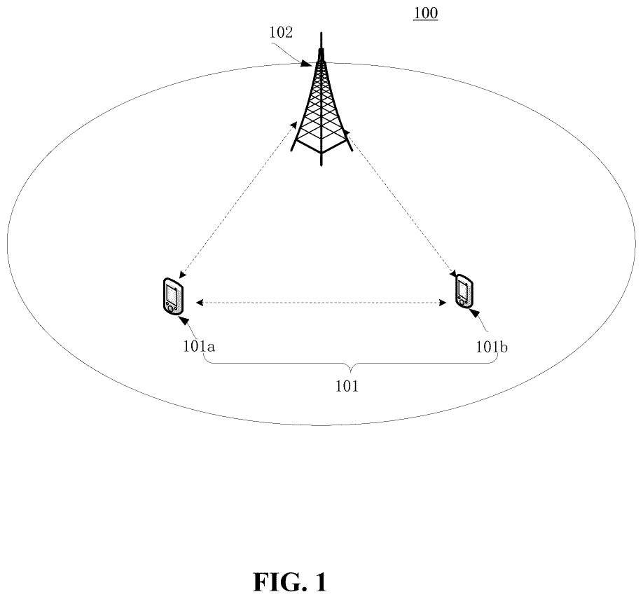

FIG. 1 is a schematic diagram illustrating an exemplary wireless communication system 100 according to an embodiment of the present application.

As shown in FIG. 1, a wireless communication system 100 includes at least one UE 101 and at least one BS 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

According to some embodiments of the present application, the UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present application, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

According to some embodiments of the present application, the UE(s) 101 may include vehicle UEs (V-UEs), vulnerable road user (VRUs), public safety UEs (PS-UEs), and/or commercial sidelink UEs (CS-UEs) that sensitive to power consumption. In an embodiment of the present application, a VRU may include a pedestrian UE (P-UE), a cyclist UE, a wheelchair UE or other UEs which requires power saving compared with a V-UE. According to some embodiments of the present application, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate directly with BSs 102 via LTE or NR Uu interface.

According to some embodiments of FIG. 1, UE 101a functions as transmitting (Tx) UE, and UE 101b functions as receiving (Rx) UE. UE 101a may exchange messages with UE 101b through a sidelink, for example, PC5 interface as defined in 3GPP TS 23.303. UE 101a may transmit information or data to other UE(s) through sidelink unicast, sidelink groupcast, or sidelink broadcast. Alternatively, according to some other embodiments of FIG. 1, UE 101b functions as Tx UE and transmits messages, UE 101a functions as Rx UE and receives the messages from UE 101b.

Both UE 101a and UE 101b in the embodiments of FIG. 1 may transmit information to BS 102 and receive control information from BS 102, for example, via LTE or NR Uu interface. BS(s) 102 may be distributed over a geographic region. In certain embodiments of the present application, each of BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. The BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

Ranging-based services are the services utilizing the distance and/or direction between two user equipment (UEs), e.g., picture sharing between friends. Typically, ranging does not require the network to deploy positioning infrastructures or provide positioning services, as it may be directly performed between two or more UEs.

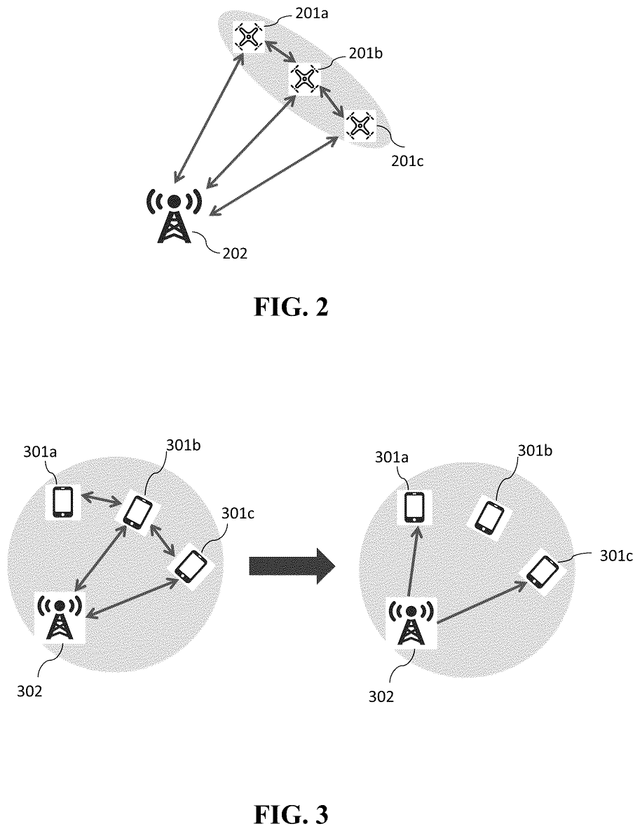

FIG. 2 illustrates an exemplary application scenario of ranging-based service according to some embodiments of the present application.

As shown in FIG. 2, the application scenario may include a BS 202 and an unpiloted aerial vehicle (UAV) swarm with at least one UAV UE 201 (e.g., UE 201a, UE 201b, and UE 201c) wirelessly communicated with the BS. Although a specific number of UEs 201 and BS 202 are depicted in FIG. 2, it is contemplated that any number of UEs 201 and BSs 202 may be included in the application scenario.

Each of the UE 201a, UE 201b, and UE 201c may transmit ranging information to the BS. The UE 201a and the UE 201b may perform ranging-based services between each other. Similarly, the UE 201b and the UE 201c may also perform ranging-based services between each other. Furthermore, the UE 201a and the UE 201c may also perform ranging-based services between each other.

The ranging information between UEs may be used to: 1) identify close UEs that may share similar link conditions, measurement results or flight paths to achieve group handover or avoid duplicated report to the network; 2) identify close UEs that may guarantee reliable radio connection (e.g. sidelink connection) routing for data transmission; 3) other applications such as maintaining swarm formation or implementing geofencing for the swarm.

There are other use cases that may benefit from ranging support in RAN. For example, FIG. 3 illustrates an exemplary application scenario of ranging-based service according to some other embodiments of the present application.

Referring to FIG. 3, it shows an epidemiological traceability application scenario. The application scenario in FIG. 3 may include a BS 302 and at least one UE 301 (e.g., UE 301a, UE 301b, and UE 301c) wirelessly communicated with the BS. Although a specific number of UEs 301 and BS 302 are depicted in FIG. 3, it is contemplated that any number of UEs 301 and BSs 302 may be included in the application scenario.

Referring to the left part of FIG. 3, the UE 301a and the UE 301b may perform ranging-based services between each other. Similarly, the UE 301b and the UE 301c may also perform ranging-based services between each other. Furthermore, the UE 301a and the UE 301c may also perform ranging-based services between each other. Each of the UE 301a, UE 301b, and UE 301c may transmit ranging information to the BS.

In epidemiological traceability, ranging information can be used to identify close contacts to a patient based on history ranging records or reports. For example, referring to right part of FIG. 3, in the case that the UE 301b is marked as a risky UE (e.g. whose owner is a diagnosed COVID-19 patient for epidemiological traceability), the BS 302 may search ranging information related to the UE 301b to find contacts (e.g., UE 301a and UE 301c) close to UE 301b based on history ranging reports, then the BS 302 may transmit dedicated suggestions or warnings to UE 301a and UE 301c.

As specified in 3GPP TS 36.305 and 3GPP TS 38.305, UE positioning in a radio access network (RAN) may use methods including network-assisted global navigation satellite system (GNSS), observed time difference of arrival (OTDOA), enhanced cell identity (ID), barometric pressure sensor, wireless local area network (WLAN), Bluetooth, terrestrial beacon system (TB S), motion sensor, etc.

Although ranging information can be derived from positioning information, ranging information does not certainly rely on positioning services which could be unavailable due to privacy or regulation restrictions. The ranging may be directly preformed between two or more UEs, which does not require deployment of positioning infrastructure or service. As stated in 3GPP TR 22.832, methods like sidelink ranging may be used to measure distances directly, while bypassing positioning. From a RAN's perspective, it may provide multiple methods for deriving ranging information. For example, the ranging information may be derived by signal measurement or transmission delay for different accuracy requirements.

To implement ranging-based services, defining the content to be included in the ranging information is necessary for the UEs. In addition, to further make use of ranging information, exchanging the ranging information between UEs or reporting the ranging information to the BS should be supported. Moreover, how the UEs and BS to take further actions based on the ranging information also needs to be defined.

However, the content of the ranging formation and reporting mechanism have not been considered in existing reporting mechanisms including measurement reporting and minimization of drive tests (MDT).

For example, as specified in 3GPP TS 38.331, next generation (NG)-RAN may configure an RRC_CONNECTED UE to perform measurements and to report them in accordance with the measurement configuration. The measurement configuration is provided by means of dedicated signalling which includes measurement objects (MOs). An MO indicates the frequency/time location and subcarrier spacing of reference signals to be measured. Measurement reporting can be triggered by events that are related to measurement results of signal (for example, reference signal receiving power (RSRP), reference signal receiving quality (RSRQ), reference signal-signal to interference plus noise Ratio (RS-SINR)) and interference, or sidelink channel busy ratio.

It is observed that ranging information is not considered either as an MO of existing measurement or as an event of triggering measurement reporting.

In addition, as specified in 3GPP TS 37.320, MDT is introduced for radio measurement collection in an immediate or logged manner. Data collected for MDT will reuse conventional results as much as possible for less power consumption and may optionally include location information of UE based on its capability. Triggering of immediate MDT can reuse the triggering events for existing measurement reporting.

It is observed that ranging information is not considered either as a content of MDT collection or as an event of triggering MDT reporting.

Given the above, in order to implement ranging-based services, the following issues need to be addressed: 1) how to define the content included in the ranging information, 2) how to define the method for reporting ranging information (e.g., via sidelink or via air interface); 3) how to trigger the report of ranging information (i.e., triggering condition for reporting the ranging information); and 4) how to notify UE(s) based on ranging information.

Accordingly, embodiments of the present application provide a technical solution for ranging-based services, which can at least solve the above issues. More details on embodiments of the present application will be illustrated in the following text in combination with the appended drawings.

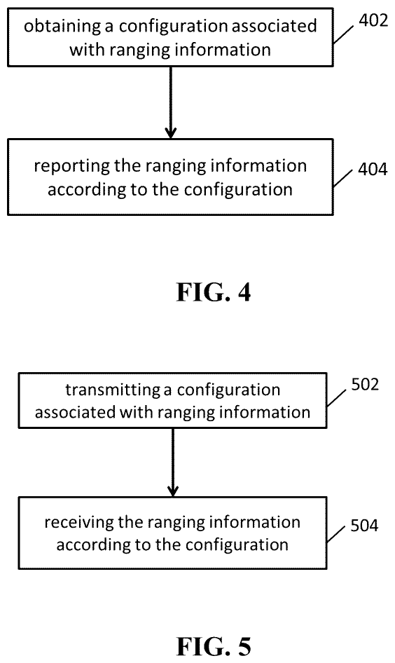

FIG. 4 is a flow chart illustrating a method for ranging-based services according to some other embodiments of the present application. The method may be performed by a UE (for example, UE 101a or UE 101b as shown in FIG. 1).

In the exemplary method shown in FIG. 4, in operation 402, a UE (for example, UE 101a) may obtain a configuration associated with ranging information. The configuration indicates content to be included in the ranging information and/or a triggering condition for reporting or recording the ranging information. In some embodiments of the present application, the ranging information may also be referred to as the ranging event. In some other embodiments of the present application, configuration associated with ranging information may also be referred to as a ranging information request or a request for ranging information.

According to some embodiments of the present application, the configuration may be obtained by a parameter set preconfigured in the UE, for example, in the subscriber identity module (SIM), universal subscriber identity module (USIM), or a memory of the UE. That is, the configuration information may be preconfigured in the UE. Therefore, obtaining configuration information may refer to accessing the SIM, USIM or the memory for acquiring the configuration information inside the UE. In these embodiments, the configuration associated with ranging information should be specified in 3GPP standard documents.

According to some embodiments of the present application, obtaining the configuration may include receiving the configuration information transmitted from a BS (e.g., the BS 102 as shown in FIG. 1). In an embodiment of the present application, the configuration information may be broadcasted in a system information block (SIB) of the BS 102 (e.g., receiving the configuration information via system information broadcasting). In another embodiment of the present application, the configuration information may be transmitted via a dedicated signalling, for example, radio resource control (RRC) signalling. That is, the first UE may receive configuration information through a RRC signalling transmitted from the BS 102.

According to some embodiments of the present application, obtaining the configuration may include receiving the configuration information transmitted from another UE (e.g., the UE 101b as shown in FIG. 1) different from the UE. In an embodiment of the present application, the configuration information may be transmitted via sidelink broadcasting. In another embodiment of the present application, the configuration information may be received via a dedicated signalling, for example, a sidelink PC5-RRC signalling. That is, the UE 101a may receive configuration information through a sidelink PC5-RRC signalling transmitted from the UE 101b.

According to some embodiments of the present application, the configuration may further include at least one of: a maximum number of UEs whose ranging information can be reported or recorded; an indication for reporting or recording the ranging information; and a destination to which the ranging information is reported.

In an embodiment of the present application, the UE 101a may obtain ranging information for at least one other UE. That is, the content included in the ranging information which is to be reported or recorded may include content for at least one other UE. In this embodiment, the maximum number may be used to constrain the number of UEs whose ranging information can be reported or recorded. For example, assuming that the maximum number is “5”, even the UE 101a may obtain ranging information for 10 UEs, it can only report or record the ranging information of 5 UEs. That is, the content included in the ranging information may only include content of 5 UEs.

In another embodiment of the present application, the indication for reporting or recording the ranging information may be used for triggering the reporting or recording the ranging information. That is, after receiving the indication, the UE may start to report or record the ranging information.

In yet another embodiment of the present application, the destination to which the ranging information is reported may be one of the BS 102, the UE 101b, or another UE which is different from the UE 101a and UE 101b.

According to some embodiments of the present application, the content included in the ranging information may include at least one of: an ID of another UE different from the UE 101a; a distance between the UE 101a and another UE is smaller or greater than a threshold; the distance between the UE 101a and another UE; a minimum, maximum, or an average distance between the UE 101a and the other UE; a time stamp for recording the ranging information; a time interval between the ranging information and a previous ranging information, a public land mobile network (PLMN) ID; a cell ID, and other contents configured by the BS or by the UE 101b.

In an embodiment of the present application, the ID of another UE may be one of: a PLMD-specific ID, a cell-specific ID, a temporary ID, and any other ID which can be used to indicate another UE.

In another embodiment of the present application, the UE 101a may obtain the ID of another UE by an existing UE discovery procedure and/or identification methods, for example, sidelink identification method or Bluetooth.

According to some embodiments of the present application, the triggering condition for reporting or recording the ranging information may include at least one of the following events:
1) an estimated distance between the UE 101a and another UE is smaller than or greater than a first threshold, wherein the estimated distance may be obtained by existing ranging methods (for example, sidelink ranging method, laser ranging method, etc.);
2) a measurement result of a reference signal (for example, sidelink reference signal receiving power (SL-RSRP), sidelink reference signal receiving quality (SL-RSRQ), signal to interference plus noise ratio (SL-SINR), etc.) from the another UE is smaller than or greater than a second threshold;
3) a transmission delay (for example, sidelink round trip time (SL-RTT)) between the UE 101a and another UE is smaller than or greater than a third threshold;
4) another UE bearing the same area ID (for example, zone ID in sidelink) as the UE 101a or bearing a neighboring area ID of the UE 101a;
5) another UE is disclosed by a discovery procedure for a short-range connection (for example, Bluetooth);
6) at least one of the above events 1)-5) lasts for a duration of time (e.g., T1, wherein T1 is large than 0);
7) at least one of the above events 1)-5) occurs a first number of times (e.g., N1, wherein N1 is a positive integer);
8) at least one of the above events 1)-5) occurs a second number of times (e.g., N2, wherein N2 is a positive integer) in a period of time (e.g., T2, wherein T2 is large than 0).

Once the trigger condition is fulfilled, the UE 101a may report or record the ranging information including the ranging content. In an embodiment of the present application, the trigger condition may be preconfigured in the UE 101a. In another embodiment of the present application, the trigger condition may be received by the BS 102 (via system information broadcasting or dedicated signalling) or received by the UE 101b (via sidelink broadcasting or sidelink dedicated signalling). In yet another embodiment of the present application, a trigger condition may be preconfigured in the UE 101a, and the UE may also receive a different trigger condition from the BS 102 or the UE 101b, then the UE 101a may report or record the ranging information based on the trigger condition received from the BS 102 or the UE 101b.

According to some embodiments of the present application, the triggering condition for reporting or recording the ranging information may include a period for reporting the ranging information. In these embodiments, the UE 101a may report or record the ranging information including the ranging content periodically based on the period.

In an embodiment of the present application, the period may be preconfigured in the UE 101a. In another embodiment of the present application, the period may be received by the BS 102 (via system information broadcasting or dedicated signalling) or received by the UE 101b (via sidelink broadcasting or sidelink dedicated signalling). In yet another embodiment of the present application, a period may be preconfigured in the UE 101a, and the UE may also receive the another period from the BS 102 or the UE 101b, then the UE 101a may report or record the ranging information based on the period received from the BS 102 or the UE 101b.

After receiving the configuration, at operation 404, the UE 101a may report or record the ranging information according to the configuration. For example, the UE 101a may report or record the ranging information including the content indicated in the configuration and/or report or record the ranging information based on the trigger condition indicated in the configuration.

According to some embodiments of the present application, the ranging information is reported to a destination which can be one of:
a source from which the configuration is received;
a destination indicated in the configuration;
a destination determined based on a UE type of the UE 101a or a role of the UE 101a. For example, in a scenario that the UE 101a in within a group and it is a member UE which is communicated with a master UE of the group, the UE 101a may report the ranging information to the master UE of the group;
a destination determined based on a distance (for example, a horizontal distance, a vertical distance, etc.) or propagation delay between the destination and the UE 101a;
a radio link condition of the UE 101a.

According to some embodiments of the present application, in the case that the destination to which the ranging information is reported is the UE 101b, the ranging information may be reported by a sidelink dedicated signalling (e.g., sidelink PC5-RRC signalling), a medium access control (MAC) control element (CE) to the UE 101b, or by a sidelink user data to the UE 101b. In the case that the destination to which the ranging information is reported is the BS 102, the ranging information may be reported to the BS 102 by a dedicated signalling (e.g., an RRC signalling), a MAC CE to the BS 102, or by a user data to the BS 102.

According to some embodiments of the present application, before receiving the configuration associated with the ranging information from a BS 102 or from a UE 101b, the UE 101a may transmit an indication indicating a capability of the UE 101a associated with the ranging information such that the BS 102 or the UE 101b may determine or transmit the configuration based on the capability of the UE 101a. The capability may include at least one of:
the UE 101a being capable of recording ranging information;
the UE 101a being capable of reporting ranging information;
the content included in ranging information that the UE 101a is capable of reporting or recording, for example, the content included in the ranging information may include at least one of: an ID of another UE different from the UE 101a; a distance between the UE 101a and another UE is smaller or greater than a threshold; the distance between the UE 101a and another UE; a minimum, maximum, or an average distance between the UE 101a and the other UE; a time stamp for recording the ranging information; a time interval between the ranging information and a previous ranging information, a PLMN ID; a cell ID, and other contents configured by the BS or by the UE 101b;
at least one triggering condition based on which the UE 101a is capable of reporting or recording the ranging information, for example, the triggering condition may be at least one of events 1)-8) previously discussed or may be a period for reporting or recording the ranging information.

According to some embodiments of the present application, before receiving the configuration associated with the ranging information from a BS 102 or from a UE 101b or before reporting the ranging information, the UE 101a may transmit an indication associated with an availability of ranging information of the UE 101a. The availability may include at least one of:
the UE 101a having ranging information to be reported;
content included in the ranging information that the UE 101a has, for example, the content included in the ranging information may include at least one of: an ID of another UE different from the UE 101a; a distance between the UE 101a and another UE is smaller or greater than a threshold; the distance between the UE 101a and another UE; a minimum, maximum, or an average distance between the UE 101a and the other UE; a time stamp for recording the ranging information; a time interval between the ranging information and a previous ranging information, a PLMN ID; a cell ID, and other contents configured by the BS or by the UE 101b;
at least one triggering condition for reporting the ranging information that the UE 101a has, for example, the triggering condition may be at least one of events 1)-8) previously discussed or may be a period for reporting or recording the ranging information.

After reporting the ranging information to a destination, the UE 101a may receive a notification from the destination. The notification may be generated based on the reported ranging information. For example, the notification may indicate the UE 101a to forward data to another UE. In another example, the notification may be a waring notification of close contact to another UE.

According to some embodiments of the present application, in the case that the destination to transmit the notification is a UE, the notification may be received via sidelink broadcasting or a sidelink dedicated signalling (e.g., a sidelink PC5-RRC signalling). In the case that the destination to transmit the notification is a BS, the notification may be received via system information broadcasting or a dedicated signalling (e.g., a RRC signalling).

FIG. 5 is a flow chart illustrating a method for ranging-based services according to some embodiments of the present application. The method may be performed by a BS (for example, a BS 102 as shown in FIG. 1) or a UE (for example, UE 101b as shown in FIG. 1).

In the exemplary method shown in FIG. 5, in operation 502, the BS 102 or the UE 101b may transmit configuration associated with ranging information to another UE (for example, UE 101a as shown in FIG. 1). The configuration indicates content to be included in the ranging information and/or a triggering condition for reporting or recording the ranging information. In some embodiments of the present application, the ranging information may also be referred to as the ranging event. In some other embodiments of the present application, configuration associated with ranging information may also be referred to as a ranging information request or a request for ranging information.

In the case that the configuration is received from the BS 102, in an embodiment of the present application, the configuration information may be broadcasted in a SIB of the BS 102 (e.g., receiving the configuration information via system information broadcasting). In another embodiment of the present application, the configuration information may be transmitted via a dedicated signalling, for example, an RRC signalling.

In the case that the configuration is received from the UE 101b, in an embodiment of the present application, the configuration information may be received via sidelink broadcasting. In another embodiment of the present application, the configuration information may be received via a dedicated signalling, for example, a sidelink PC5-RRC signalling.

According to some embodiments of the present application, the configuration may include at least one of: a maximum number of UEs whose ranging information can be reported or recorded; an indication for reporting or recording the ranging information; and a destination to which the ranging information is reported.

According to some embodiments of the present application, the content included in the ranging information may include at least one of: an ID of another UE different from the UE 101a; a distance between the UE 101a and another UE is smaller or greater than a threshold; the distance between the UE 101a and another UE; a minimum, maximum, or an average distance between the UE 101a and the other UE; a time stamp for recording the ranging information; a time interval between the ranging information and a previous ranging information, a PLMN ID; a cell ID, and other contents configured by the BS or by the UE 101b.

According to some embodiments of the present application, the triggering condition for reporting or recording the ranging information may include at least one of the following events:
1) an estimated distance between the UE 101a and another UE is smaller than or greater than a first threshold, wherein the estimated distance may be obtained by existing ranging methods (for example, sidelink ranging method, laser ranging method, etc.);
2) a measurement result of a reference signal (for example, sidelink reference signal receiving power (SL-RSRP), sidelink reference signal receiving quality (SL-RSRQ), signal to interference plus noise ratio (SL-SINR), etc.) from the another UE is smaller than or greater than a second threshold;
3) a transmission delay (for example, sidelink round trip time (SL-RTT)) between the UE 101a and another UE is smaller than or greater than a third threshold;
4) another UE bearing the same area ID (for example, zone ID in sidelink) as the UE 101a or bearing a neighboring area ID of the UE 101a;
5) another UE is disclosed by a discovery procedure for a short-range connection (for example, Bluetooth);
6) at least one of the above events 1)-5) lasts for a duration of time (e.g., T1, wherein T1 is large than 0);
7) at least one of the above events 1)-5) occurs a first number of times (e.g., N1, wherein N1 is a positive integer);
8) at least one of the above events 1)-5) occurs a second number of times (e.g., N2, wherein N2 is a positive integer) in a period of time (e.g., T2, wherein T2 is large than 0).

According to some embodiments of the present application, the triggering condition for reporting or recording the ranging information may include a period for reporting the ranging information. In these embodiments, the BS 102 and the UE 101b may receive the ranging information including the ranging content periodically based on the period.

After transmitting the configuration, in the case that the destination to which the ranging information is reported is the same as the source transmitting the configuration, at operation 504, the BS 102 or the UE 101b may receive the ranging information according to the configuration. For example, the BS 102 or the UE 101b may receive the ranging information including the content indicated in the configuration and/or receive the ranging information based on the trigger condition indicated in the configuration.

According to some embodiments of the present application, before transmitting the configuration associated with the ranging information from a BS 102 or from a UE 101b, the BS 102 or the UE 101b may receive an indication indicating a capability of the UE 101a associated with the ranging information from the UE 101a. The capability of the UE 101a may be the same as the embodiments as discussed in accordance with FIG. 4. After receiving the capability of the UE 101a, the BS 102 or the UE 101b may determine the configuration based on the capability of the UE 101a.

According to some embodiments of the present application, before transmitting the configuration associated with the ranging information from a BS 102 or from a UE 101b or before receiving the ranging information, the BS 102 or the UE 101b may receive an indication associated with an availability of ranging information of the UE 101a. The availability may be the same as the embodiments as discussed in accordance with FIG. 4.

After receiving the ranging information, the BS 102 or the UE 101b may transmit a notification to the UE 101a. The notification may be generated based on the reported ranging information. For example, the notification may indicate the UE 101a to forward data to another UE. In another example, the notification may be a waring notification of close contact to another UE.

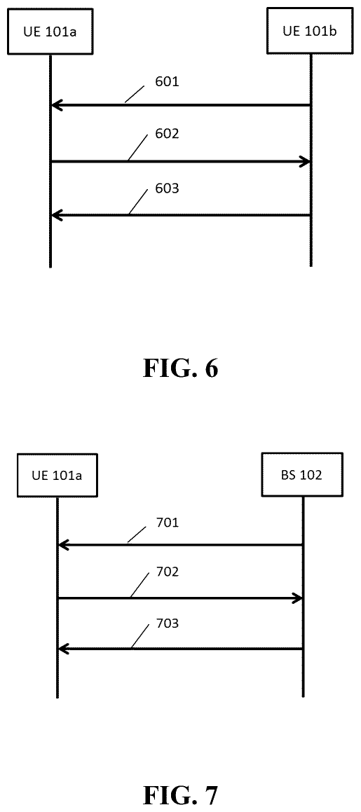

FIG. 6 is an exemplary method for ranging-based services according to some embodiments of the present application. The method in FIG. 6 may be performed by two UEs (e.g., the UE 101a and the UE 101b as shown in FIG. 1).

Referring to FIG. 6, at operation 601, the UE 101b may transmit configuration associated with ranging information to the UE 101a via sidelink broadcasting or a dedicated signalling. The information included and/or indicated in the configuration may be the same as those in the embodiments discussed in accordance with FIGS. 4 and 5. For example, the configuration may indicate content to be included in the ranging information and/or a triggering condition for reporting the ranging information.

After receiving the configuration, the UE 101a may determine ranging information for one or more other UEs. For example, the UE 101a may determine the content to be included in the ranging information. Once the trigger condition for reporting the ranging information is fulfilled, at operation 602, the UE may report the ranging information of at least one (e.g., UE 101c, UE 101d, and UE 101e not shown in FIG. 1) of the one or more other UEs to the UE 101b.

After receiving the ranging information, in some cases, the UE 101b may need to transmit data to UE 101c without direct radio connection, then the UE 101b may search for record related to UE 101c in the reported ranging information and knows that the UE 101a may have connection to it. Then, at operation 603, the UE 101b may transmit data to UE 101a and requests the UE 101a to forward it to the UE 101c.

FIG. 7 is an exemplary method for ranging-based services according to some other embodiments of the present application. The method in FIG. 7 may be performed by a UE and a BS (e.g., the UE 101a and the BS 102 as shown in FIG. 1).

Referring to FIG. 7, at operation 701, the BS 102 may transmit configuration associated with ranging information to the UE 101a via system information broadcasting or a dedicated signalling. The information included and/or indicated in the configuration may be the same as that in the embodiments of FIGS. 4 and 5. For example, the configuration may indicate content to be included in the ranging information and/or a first triggering condition for reporting the ranging information.

After receiving the configuration, the UE 101a may determine ranging information for one or more other UEs. For example, the UE 101a may determine the content to be included in the ranging information. Once the trigger condition for reporting the ranging information is fulfilled, at operation 702, the UE may report the ranging information of at least one (e.g., UE 101c, UE 101d, and UE 101e not shown in FIG. 1) of the one or more other UEs to the BS 102.

After receiving the ranging information, in some cases, the BS 102 may mark UE 101d as a risky UE (e.g. whose owner is a diagnosed COVID-19 patient for epidemiological traceability), then, the BS 102 may search for record related to UE 101d in the reported ranging information and finds that the UE 101a has contacted it. Then, at operation 702, the BS 102 may transmit a warning notification of close contact to the UE 101a.

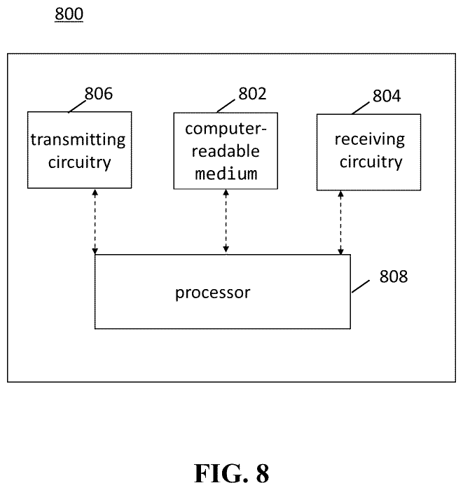

FIG. 8 illustrates a simplified block diagram of an apparatus 800 for ranging-based services according to some embodiments of the present application. The apparatus 800 may be a BS 102 or a UE 101 (e.g., UE 101a or UE 101b) as shown in FIG. 1.

Referring to FIG. 8, the apparatus 800 may include at least one non-transitory computer-readable medium 802, at least one receiving circuitry 804, at least one transmitting circuitry 806, and at least one processor 808. In some embodiment of the present application, at least one receiving circuitry 804 and at least one transmitting circuitry 806 can be integrated into at least one transceiver. The at least one non-transitory computer-readable medium 802 may have computer executable instructions stored therein. The at least one processor 808 may be coupled to the at least one non-transitory computer-readable medium 802, the at least one receiving circuitry 804 and the at least one transmitting circuitry 806. The computer executable instructions can be programmed to implement a method with the at least one receiving circuitry 804, the at least one transmitting circuitry 806 and the at least one processor 808. The method can be a method according to an embodiment of the present application, for example, the method shown in FIG. 4 or 5.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for ranging-based services, including a processor and a memory. Computer programmable instructions for implementing a method for ranging-based services are stored in the memory, and the processor is configured to perform the computer programmable instructions to implement the method for ranging-based services. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for ranging-based services as stated above or other method according to an embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. An apparatus, comprising:
at least one non-transitory computer-readable medium having computer executable instructions stored therein;
at least one receiving circuitry;
at least one transmitting circuitry; and
at least one processor coupled to the at least one non-transitory computer-readable medium, the at least one receiving circuitry and the at least one transmitting circuitry,
wherein when the computer executable instructions are executed by the at least one processor, causing the apparatus to implement a method, the method comprising:
obtaining, at a first user equipment (UE), a configuration associated with ranging information, wherein the configuration indicates content to be included in the ranging information and/or a first triggering condition for reporting the ranging information; and
reporting the ranging information according to the configuration.

2. The apparatus of claim 1, wherein the configuration is obtained by at least one of:
a parameter set preconfigured in the first UE;
receiving via system information or a dedicated signaling from a base station (BS); and
receiving via system information or a dedicated signaling from a second UE different from the first UE.

3. The apparatus of claim 1, wherein the configuration further comprises at least one of:
a maximum number of second UEs whose ranging information can be reported;
an indication for reporting the ranging information; and
a destination to which the ranging information is reported.

4. The apparatus of claim 1, wherein the content included in the ranging information comprises at least one of:
an identity (ID) of a second UE different from the first UE;
a distance between the first UE and the second UE is smaller or larger than a threshold;
the distance between the first UE and the second UE;
a minimum, maximum, or an average distance between the first UE and the second UE;
a time stamp for recording the ranging information;
a time interval between the ranging information and a previous ranging information;
a public land mobile network (PLMN) ID; and
a cell ID.

5. The apparatus of claim 1, wherein the first triggering condition for reporting the ranging information comprises at least one of the following events:
1) an estimated distance between the first UE and the second UE is smaller than or larger than a first threshold;
2) a measurement result of a reference signal from the second UE is smaller than or larger than a second threshold;
3) a transmission delay between the first UE and the second UE is smaller than or larger than a third threshold;
4) the second UE bearing the same area ID as the first UE or bearing a neighboring area ID of the first UE;
5) the second UE is disclosed by a discovery procedure for a short-range connection;
6) at least one of the above events 1)-5) lasts for a duration of time;
7) at least one of the above events 1)-5) occurs a first number of times; and
8) at least one of the above events 1)-5) occurs a second number of times in a period of time;
wherein the method further comprises: reporting the ranging information in response to the first triggering condition is fulfilled.

6. The apparatus of claim 1, wherein the first triggering condition for reporting the ranging information comprises a period for reporting the ranging information, and wherein the method further comprises: periodically reporting the ranging information based on the period.

7. The apparatus of claim 1, wherein the ranging information is reported to a destination which is one of:
a source from which the configuration is received;
a destination indicated in the configuration;
a destination determined based on a UE type;
a destination determined based on a distance or propagation delay between the destination and the first UE; and
a radio link condition of the first UE.

8. The apparatus of claim 1, further comprising:
transmitting an indication indicating a capability of the first UE associated with the ranging information, wherein the capability comprises at least one of:
the first UE being capable of recording ranging information;
the first UE being capable of reporting ranging information;
the content included in ranging information that the first UE is capable of reporting; and
at least one triggering condition based on which the first UE is capable of reporting the ranging information.

9. An apparatus, comprising:
at least one non-transitory computer-readable medium having computer executable instructions stored therein;
at least one receiving circuitry;
at least one transmitting circuitry; and
at least one processor coupled to the at least one non-transitory computer-readable medium, the at least one receiving circuitry and the at least one transmitting circuitry, wherein when the computer executable instructions are executed by the at least one processor, causing the apparatus to implement a method, the method, comprising:
transmitting, to a first user equipment (UE), a configuration for ranging information, wherein the configuration indicates content included in the ranging information and/or a first triggering condition for reporting the ranging information; and
receiving the ranging information according to the configuration.

10. The apparatus of claim 9, wherein the configuration further comprises at least one of:
a maximum number of second UEs whose ranging information can be reported;
an indication for reporting the ranging information; and
a destination to which the ranging information is reported.

11. The apparatus of claim 9, wherein the content included in the ranging information comprises at least one of:
an identity (ID) of a second UE different from the first UE;
a distance between the first UE and the second UE is smaller or larger than a threshold;
the distance between the first UE and the second UE;
a minimum, maximum, or an average distance between the first UE and the second UE;
a time stamp for recording the ranging information;
a time interval between the ranging information and a previous ranging information;
a public land mobile network (PLMN) ID; and
a cell ID.

12. The apparatus of claim 9, wherein the first triggering condition for reporting the ranging information comprises at least one of the following events:
1) an estimated distances between the first UE and the second UE is smaller than or larger than a threshold;
2) a measurement result of a reference signal from the second UE is smaller than or larger than a threshold;
3) a transmission delay between the first UE and the second UE is smaller than or larger than a threshold;
4) the second UE bearing the same area ID as the first UE or bearing a neighboring area ID of the first UE;
5) the second UE is disclosed by a discovery procedure for a short-range connection;
6) at least one of the above events 1)-5) lasts for a duration of time;
7) at least one of the above events 1)-5) occurs a first number of times; and
8) at least one of the above events 1)-5) occurs a second number of times in a period of time.

13. The apparatus of claim 9, wherein the first triggering condition for reporting the ranging information comprises a period for reporting the ranging information.

14. The apparatus of claim 9, further comprising:
receiving an indication indicating capability of the first UE associated with the ranging information, wherein the capability comprises at least one of:
the first UE being capable of recording ranging information;
the first UE being capable of reporting ranging information;
the content included in ranging information that the first UE is capable of reporting; and
at least one triggering condition based on which first UE is capable of reporting the ranging information.

15. (canceled)

16. A method, comprising:
obtaining, at a first user equipment (UE), a configuration associated with ranging information, wherein the configuration indicates content to be included in the ranging information and/or a first triggering condition for reporting the ranging information; and
reporting the ranging information according to the configuration.

17. The method of claim 16, wherein the configuration is obtained by at least one of:
a parameter set preconfigured in the first UE;
receiving via system information or a dedicated signaling from a base station (BS); and
receiving via system information or a dedicated signaling from a second UE different from the first UE.

18. The method of claim 16, wherein the configuration further comprises at least one of:
a maximum number of second UEs whose ranging information can be reported;
an indication for reporting the ranging information; and
a destination to which the ranging information is reported.

19. The method of claim 16, wherein the content included in the ranging information comprises at least one of:
an identity (ID) of a second UE different from the first UE;
a distance between the first UE and the second UE is smaller or larger than a threshold;
the distance between the first UE and the second UE;
a minimum, maximum, or an average distance between the first UE and the second UE;
a time stamp for recording the ranging information;
a time interval between the ranging information and a previous ranging information;
a public land mobile network (PLMN) ID; and
a cell ID.

20. The method of claim 16, wherein the first triggering condition for reporting the ranging information comprises at least one of the following events:
1) an estimated distance between the first UE and the second UE is smaller than or larger than a first threshold;
2) a measurement result of a reference signal from the second UE is smaller than or larger than a second threshold;
3) a transmission delay between the first UE and the second UE is smaller than or larger than a third threshold;
4) the second UE bearing the same area ID as the first UE or bearing a neighboring area ID of the first UE;
5) the second UE is disclosed by a discovery procedure for a short-range connection;
6) at least one of the above events 1)-5) lasts for a duration of time;
7) at least one of the above events 1)-5) occurs a first number of times; and
8) at least one of the above events 1)-5) occurs a second number of times in a period of time;
wherein the method further comprises: reporting the ranging information in response to the first triggering condition is fulfilled.

21. The method of claim 16, wherein the first triggering condition for reporting the ranging information comprises a period for reporting the ranging information, and wherein the method further comprises: periodically reporting the ranging information based on the period.
